(19) United States
(12) Patent Application Publication
(10) Pub. No.: US 2010/0011922 A1
(43) Pub. Date: Jan. 21, 2010

(54) APPARATUS AND METHOD FOR SHAPED CUTTING AND SLITTING OF FOOD PRODUCTS

(76) Inventor: Roberto Capodieci, Glen Ellyn, IL (US)

Correspondence Address: PAULEY PETERSEN & ERICKSON, 2800 WEST HIGGINS ROAD, SUITE 365, HOFFMAN ESTATES, IL, 60169, US

(21) Appl. No.: 12/499,629

(22) Filed: Jul. 8, 2009

Related U.S. Application Data
(63) Continuation of application No. 10/718,255, filed on Nov. 20, 2003, now abandoned.
(60) Provisional application No. 60/427,729, filed on Nov. 20, 2002.

(51) Int. Cl. A21C 11/10; B26D 1/00

(52) U.S. Cl. 83/14; 83/701; 426/238

(57) ABSTRACT

An apparatus for cutting food product includes an ultrasonic resonant horn. A reciprocating cutting tool is mounted with respect to the ultrasonic resonant horn, and includes a plurality of longitudinally oriented first cutting blades and a plurality of transversely oriented second cutting blades. Each second cutting blade is positioned between and connected with adjacent first cutting blades. Also disclosed is a method for forming a plurality of food product cubes from a food product base.

### CROSS REFERENCE TO RELATED APPLICATION

This application is a continuation of U.S. patent application Ser. No. 10/718,255, filed on 20 Nov. 2003. The co-pending parent Patent Application is hereby incorporated by reference herein in its entirety and is made a part hereof, including but not limited to those portions which specifically appear hereinafter.

### BACKGROUND OF THE INVENTION

1. Field of Invention

This invention relates generally to an apparatus and method for cutting food product. More specifically, this invention relates to an apparatus and method for ultrasonically forming a plurality of food product pieces from a food product base or source.

2. Description of Related Art

Forming food products on an industrial basis by slitting and cutting food product base to form the food products into desired shapes and/or sizes has always posed significant challenges. On one hand, the composition and consistency of the food product required accurate formulation and suitable conditioning to prevent product distortion, contain within acceptable limits product build-up on the cutting blades, and minimize food product waste and scrap. On the other hand, the cutting systems necessitate over-designed drive mechanisms for withstanding high cutting forces, and a number of gadgets and components, such as blade wipers, vibrators, lubricators and stalls.

Prior art systems were designed and developed to enhance cutting performance, keep the cutting blades clean and control the position of the food product during and after the cut, so that the cut food product could be subsequently processed. The designs and developments, beside adding complexity to the overall system and requiring significant operational down time for sanitation and maintenance of the components, required the use of straight and flat blades. However, the use of straight and flat blades necessarily limits the cutting and slitting action to straight lines and planes, thereby limiting the resulting food product to traditional parallelopiped shaped pieces.

With the advent of ultrasonic cutting, designers replace the old mechanical cutting blades with cutting systems operatively connected to ultrasonically resonant horns with the same characteristics, i.e. straight, flat cutting blades, in essence perpetuating the traditional food product shapes.

The invention of ultrasonic forming, for example as taught in U.S. Pat. No. 5,861,185 issued to Capodieci, represents a departure from this conservative approach. Capodieci teaches the use of uniquely-shaped cavities that offer an array of options ranging from complex silhouettes to highly detailed, fully three dimensional food products. This technology, although highly elegant and effective, has some limitations. For example, making silhouette food product pieces from a slab of food product base inevitably entails the production of an extensive scrap web with all its obvious side effects. Because of the nature of the manufacturing process, individual food product pieces are punched from a continuous food product slab or sheet, thereby leaving a substantial web of scrap product which must be disposed of, either as waste or reintroduced into the process. Additionally, for certain products having predictable cutting characteristics, where simpler silhouette shapes are required, this technology might not be the most efficient and cost effective solution.

### SUMMARY OF THE INVENTION

A general object of the invention is to provide an improved apparatus and method for forming food product.

A more specific objective of the invention is to overcome one or more of the problems described above.

The general object of this invention can be attained through an apparatus and method which provides for the manufacture of uniquely shaped food product pieces using a cutting and/or slitting tool operatively connected to an ultrasonic resonant horn. In one preferred embodiment of this invention, the cutting tool includes a plurality of longitudinally oriented first cutting blades and a plurality of transversely oriented second cutting blades. Each of the second cutting blades is positioned between adjacent first cutting blades to form a continuous cutting pattern having longitudinally oriented slits and transversely oriented cuts, wherein successive cutting patterns form a plurality of substantially identical food product cubes.

In one preferred embodiment of this invention, the cutting tool includes one or more suitably driven profiled cutting blades, which engage longitudinally a slab of food product, thereby slitting the food product slab along a pattern established by the blades' shape to form a plurality of food product strips. An array of suitably driven, profiled cutting blades engage the food product strips transversely further downstream. The result, in all cases, is a plurality of food product pieces each having side edges, as well as leading and rear edges, having with corresponding shapes of the slitting and cutting blades. The profiled cutting blades have cutting surfaces or edges that are profiled and shaped in such a way to impart to the formed food product pieces a variety of corresponding curvilinear, zigzag or complex edges.

In one preferred embodiment of this invention, the cutting tool can be used to form a plurality of substantially identical, individual food product pieces from a continuous food product base, such as a slab, rope or strip of food product, using any suitable profiled cutting blade to impart various shaped cuts on a food product strip. Additionally, various cuts can be imparted on preformed or preshaped food products to form shaped food product pieces, according to one preferred embodiment of this invention.

In the case of granola, cereal bars, multi-layered sponge cakes, cookies and a variety of other baked or moderately sticky goods, this invention provides uniquely shaped, value added line extensions to anonymously shaped food products, that are highly appealing and desirable to consumers (of children's novelty snacks, for example).

The term “machine direction” as used throughout the specification and in the claims refers to a length of a food product base, such as a food product slab or food product strip, in a direction in which the food product base is produced.

The term “cross machine direction” as used throughout the specification and in the claims refers to a width of a food product base, such as a food product slab or food product strip, in a direction generally perpendicular to the machine direction.

Other objects and advantages will be apparent to those skilled in the art from the following detailed description taken in conjunction with the appended claims and drawings.

### BRIEF DESCRIPTION OF THE DRAWINGS

The present invention can be better understood with reference to the following drawings. In the drawings, like reference numerals designate corresponding parts throughout the several views. Moreover, it should be noted that the drawings are not necessarily to scale, emphasis instead being placed upon clearly illustrating principles of the present invention.

FIG. 1A is a perspective view of a cutting tool connected to a supporting ultrasonic horn for cutting food product, according to one preferred embodiment of this invention;

FIG. 1B is a bottom view of the cutting tool shown in FIG. 1A, according to one preferred embodiment of this invention;

FIG. 2 is a top view of a cutting pattern generated by the cutting tool shown in FIG. 1A, according to one preferred embodiment of this invention;

FIG. 3 illustrates a top view of three composite blade elements forming a cutting tool for cutting food product, according to one preferred embodiment of this invention;

FIG. 4 is a perspective view of a cutting tool connected to a supporting ultrasonic horn and having a profiled cutting blade, which imparts a wave-shaped profile cut, according to one preferred embodiment of this invention;

FIG. 5 is a perspective view of a cutting tool integrated with a supporting ultrasonic horn and having a profiled cutting blade, which imparts an arcuate-shaped profile cut, according to one preferred embodiment of this invention;

FIG. 6 is a perspective view of a cutting tool integrated with a supporting ultrasonic horn and having a profiled cutting blade, which imparts a wave-shaped profile cut, according to one preferred embodiment of this invention;

FIGS. 7A through 7K are top perspective views of profiled cutting blades for imparting various shaped cuts on a food product strip, according to one preferred embodiment of this invention; and

FIGS. 8A through 8K are top views of various cuts imparted onto preshaped food product pieces, according to one preferred embodiment of this invention.

### DETAILED DESCRIPTION OF THE INVENTION

The present invention provides an apparatus and method for cutting a food product, wherein a reciprocating cutting tool is mounted with respect to an ultrasonic resonant horn. The apparatus and method of the present invention can be used to slit, cut and/or shape any suitable food product, such as candy or confectionary food products, granola, cereal bars, sponge cakes, cookies, wafers and a variety of other baked or moderately sticky goods.

In one preferred embodiment of this invention, an apparatus 10 for forming a plurality of food product pieces, such as cubes, from a food product base, such as a continuous slab or sheet of food product, comprises an ultrasonic tool 15 including an ultrasonic resonant horn 20. Preferably, the ultrasonic horn 20 resonates at a frequency of at least about 10 KHz, and within a frequency range of about 10 KHz to at least about 40 KHz, with 20 KHz, 30 KHz, and 40 KHz being the most preferred frequencies. The chosen frequency is determined by taking into account a variety of factors, such as the complexity of the shaped or profiled cutting tool blade, the product dimensions, audibility issues and intrinsic reliability. It is apparent to those having skill in the art that any suitable ultrasonic system which includes a suitable ultrasonic horn can be used to generate and transfer sufficient ultrasonic energy to a cutting tool 30 mounted with respect to or operatively connected to ultrasonic horn 20 to cut and/or slit the food product base. As used throughout the specification and claims, the terms “cutting tool” and “horn” are generally distinguished by the function of the respective element. In practice, the cutting edges of cutting tool 30 may be: (1) machined or EDM'd into the face of horn 20; (2) attached or integrated with horn 20 as non-resonant blade elements; and/or (3) attached or integrated with horn 20 as full resonant blade elements.

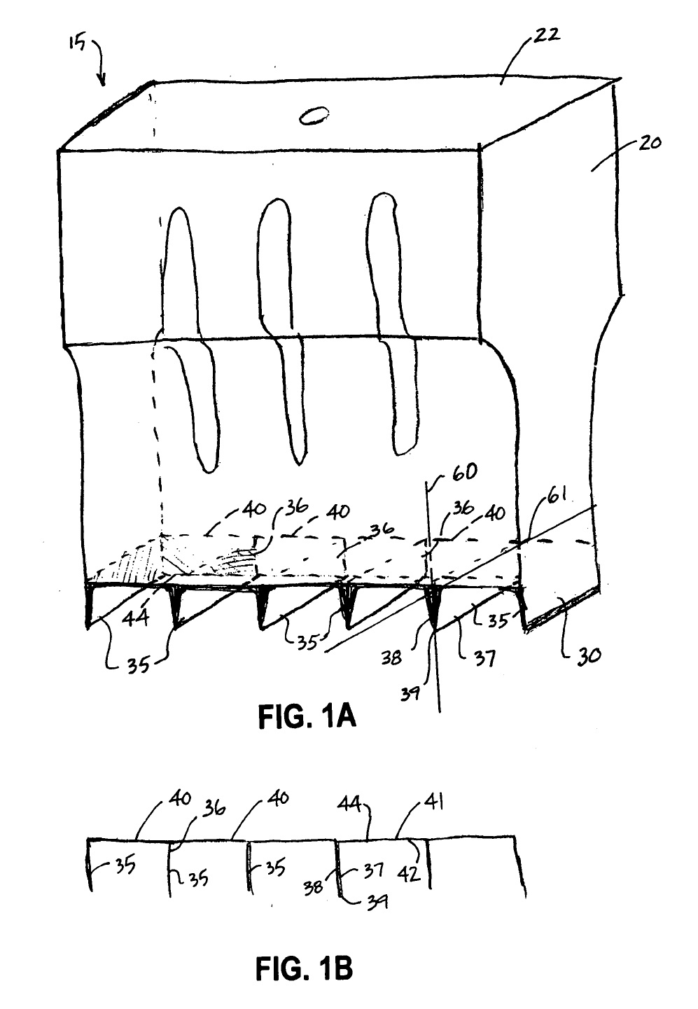

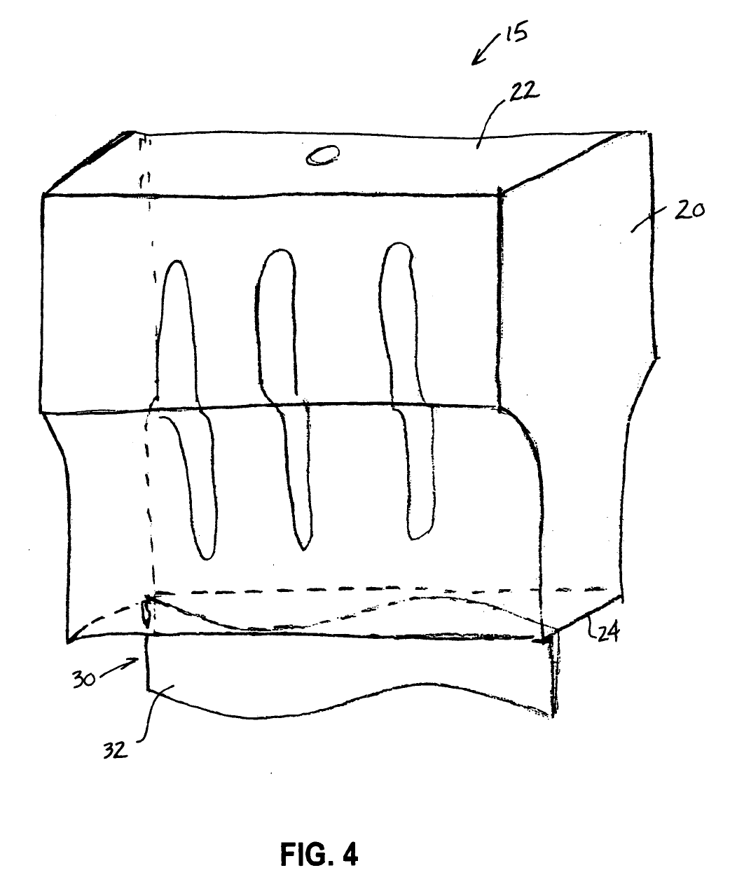

Preferably, a power supply furnishes electrical energy to a converter, wherein high frequency (20 KHz or higher) electric energy is transduced into vibratory mechanical motion, preferably by a plurality of piezoelectric transducer devices. The output of the converter may be amplified, if needed, in what is termed a booster assembly, which also provides a second clamping point at its nodal ring for mechanical stability. The output end face of the booster is secured by suitable means to an upper or input end 22 of ultrasonic horn 20. Cutting tool 30 is operatively connected or mounted with respect to ultrasonic resonant horn 20, preferably at a lower or output end 24 of ultrasonic horn 20. For example as shown in FIGS. 1 and 4-6, cutting tool 30 is integrated with, connected to or otherwise mounted to ultrasonic horn 20. Cutting tool 30 may be removably mounted or connected to ultrasonic horn 20, as shown in FIGS. 1 and 4, or may be integrated with ultrasonic horn 20, as shown in FIGS. 5 and 6.

An input conveyor preferably having a continuous serpentine belt is used to convey a continuous slab and/or continuous individual strips or ropes of food product base or material to ultrasonic tool 15. A mixer/extruder or similar source may be used to form the continuous food product base. Preferably, the continuous food product base has a generally uniform cross-section and a self-sustaining shape. The continuous food product strip may be only one of several strips formed from a food product slab of much greater width, but preferably having the same height and consistency. The method or process according to this invention may therefore call for forming a food product slab from which several food product strips are cut and advanced as described herein.

In one preferred embodiment of this invention as shown in FIGS. 1A-3, cutting tool 30 comprises a plurality of longitudinally oriented first cutting blades 35 and a plurality of transversely oriented second cutting blades 40 mounted or connected with respect to first cutting blades 35. In an alternate preferred embodiment of this invention, cutting tool 30 comprises a single, continuous second cutting blade 40 that extends along a width of cutting tool 30, wherein first cutting blades 35 are connected with respect to second cutting blade 40 at spaced apart locations along a length of second cutting blade 40 to form or define second cutting blade segments between adjacent first cutting blades 35. Thus, a “second cutting blade” as used throughout this specification and in the claims may include a single, continuous second cutting blade that is “segmented” or “divided” by an intersection of each of a plurality of longitudinally oriented first cutting blades 35 with surface 42 of second cutting blade 40, or second cutting blade 40 may comprise a plurality of second cutting blades 40 with longitudinally oriented first cutting blades 35 connected with respect to each end portion of each second cutting blade 40. Cutting tool 30 preferably comprises an alternating pattern of first cutting blades 35 and second cutting blades 40.

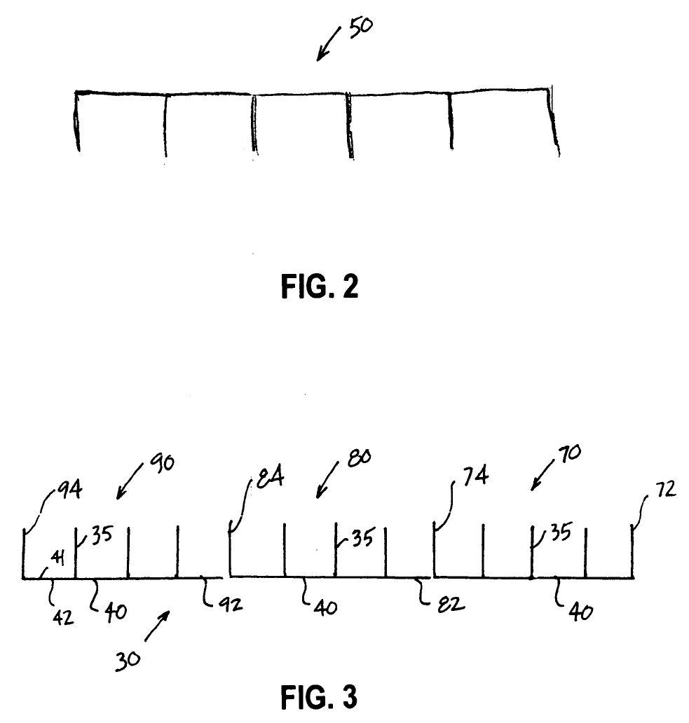

Preferably, but not necessarily, at least a portion of each first cutting blade 35 and at least a portion of each second cutting blade 40 comprises a polished carbide coating. For example, in one preferred embodiment of this invention, each first cutting blade 35 and each second cutting blade 40 comprises a polished carbide cutting edge 39 and 44, respectively. Alternatively, a similar coating or treatment may be implemented on or in connection with at least a portion of first cutting blade 35 and/or second cutting blade 40 so as to provide lubricity for added release of food product as well as greater wearability and longer blade life. As shown in FIGS. 1A and 1B, each second cutting blade 40 is positioned between and connected with adjacent first cutting blades 35. Preferably, second cutting blade 40 is positioned with respect to and/or connected to a first end portion 36 of each of the adjacent first cutting blades 35. In one preferred embodiment of this invention, a continuous cutting pattern 50, as shown in FIG. 2, is formed in the food product slab by cutting tool 30, wherein longitudinally oriented slits are formed in a machine direction of the food product slab by longitudinally oriented first cutting blades 35 and transversely oriented cuts are formed in a cross-machine direction of the food product slab by transversely oriented second cutting blades 40.

In one preferred embodiment of this invention, each first cutting blade 35 and each second cutting blade 40 has a cutting depth of about 1 mm to about 100 mm, more preferably about 15 mm. Further, adjacent first cutting blades 35 are preferably positioned at about 3 mm apart to about 300 mm apart, more preferably about 30 mm apart. It should be apparent to those skilled in the art that first cutting blades 35 and second cutting blades 40 can have any suitable dimensions, including a cutting blade length, a cutting blade height and cutting blade thickness. Preferably, but not necessarily, first cutting blades 35 and second cutting blades 40 have the same or similar cutting blade height to provide uniform cutting depths. However, first cutting blades 35 and second cutting blades 40 can have different blade lengths to form parellpiped food product pieces having any desirable length and width.

In one preferred embodiment of this invention, each first cutting blade 35 comprises a first blade surface 37 and an opposing second blade surface 38. As shown in FIGS. 1A and 1B, first blade surface 37 and second blade surface 38 converge in a bevel towards a cutting edge 39 of first cutting blade 35. Preferably, each blade surface 37, 38 is oriented at an angle of about 2° to about 10°, more preferably about 3° with respect to a vertical plane 60 which extends along a longitudinal axis 61 of first cutting blade 35. Similarly, each second cutting blade 40 preferably comprises a first blade surface 41 and an opposing second blade surface 42, as shown in FIG. 3, which converge in a bevel towards a cutting edge 44 of second cutting blade 40, preferably oriented at an angle of about 2° to about 10°, more preferably about 3° with respect to a vertical plane which extends along a longitudinal axis of second cutting blade 40. As described, the bevel of first cutting blade 35 and/or second cutting blade 40 may be symmetrical, as shown in FIG. 3, wherein each respective angle is generally equal or assymmetrical wherein each respective angle is different or one blade surface includes an angle and the opposite blade surface is generally vertical.

Cutting tool 30 as shown in FIGS. 1A and 1B may be limited in size based upon the dynamic limitations of ultrasonic cutting. Accordingly, in one preferred embodiment of this invention, multiple or composite blade elements may be aligned end-to-end or side-to-side, as shown in FIG. 3, to create a cutting tool 30 comprising longitudinally oriented first cutting blades 35 spaced apart from each other by transversely oriented second cutting blades 40. This arrangement improves the stability of cutting tool 30 and the uniformity of the respective cuts.

In one preferred embodiment of this invention, reciprocating cutting tool 30 comprises at least two transversely oriented composite blade elements forming a continuous cutting pattern. Preferably, at least one of the composite blade elements has an open first end connected with respect to or abuts a closed end of an adjacent composite blade element. The composite blade elements are preferably oriented in a transverse direction with respect to the food product slab or sheet being conveyed or moved towards cutting tool 30. For example, as shown in FIG. 3, cutting tool 30 comprises three composite blade elements 70, 80 and 90, which are positioned in a side-by-side orientation or arrangement. Preferably, first composite blade element 70 comprises at least two longitudinally oriented first cutting blades 35 and at least one transversely oriented second cutting blade 40. Each second cutting blade 40 is positioned between and connected to adjacent first cutting blades 35 to form two opposing closed ends 72, 74. Composite blade elements 80, 90 comprise an open end 82, 92 and comprise at least one longitudinally oriented first cutting blade 35 and at least one transversely oriented second cutting blade 40. As shown in FIG. 3, composite blade open end 82 is adjacent and abuts closed end 74 and open end 92 is adjacent and abuts a closed end 84 of composite blade element 80. Thus, each remaining composite blade element 80, 90, for example, comprises open end 82, 92, respectively, and a closed end 84, 94, respectively, so that any number of composite blade elements can be added to first composite blade element 70 to form cutting tool 30 having a suitable length to correspond with a width of the food product slab conveyed through apparatus 10.

Cutting tool 30 may be used to simultaneously slit and cut the food product base using longitudinally oriented first cutting blades 35 and transversely oriented second cutting blades 40 attached to a single ultrasonic resonant horn 20. Such simultaneous slitting and cutting avoids creation of a web and permits sectioning of a continuous food product slab or sheet into individual food product pieces.

Apparatus 10 of the present invention can be utilized to form a plurality of substantially identical food product pieces, for example rows of substantially identical food product cubes, from a continuous food product base, such as a slab or sheet of a food product. Alternatively, or in addition, apparatus 10 may form food product shapes of a predetermined size that are not entirely identical, for instance so as to reproduce a homemade appearance. The method according to one preferred embodiment of this invention forms a plurality of food product cubes from a food product base. The food product base is formed into a food product slab or sheet. The food product slab is conveyed through apparatus 10, which comprises ultrasonic resonant horn 20 and reciprocating cutting tool 30 mounted with respect to ultrasonic resonant horn 20. Preferably, the cutting tool 30 comprises a plurality of longitudinally oriented first cutting blades 35 and a plurality of transversely oriented second cutting blades 40. Each second cutting blade 40 is positioned between and connected with adjacent first cutting blades 35.

A continuous first cutting pattern 50 is formed in the food product slab. Preferably, continuous first cutting pattern 50 is formed in a transverse orientation with respect to the food product slab, i.e. in the cross-machine direction. The first cutting pattern 50 is formed in the food product slab using ultrasonic energy transferred from ultrasonic resonant horn 20 to cutting tool 30. Continuous first cutting pattern 50 is formed by simultaneously forming with longitudinally oriented first cutting blades 35 a plurality of longitudinally oriented slits in the food product slab and forming with transversely oriented second cutting blades 40 a plurality of transversely oriented cuts in the food product slab between adjacent slits. The food product slab is advanced with respect to cutting tool 30 as cutting tool 30 reciprocates.

For example, cutting tool 30 is moved away from the food product slab, in a generally vertical direction with respect to the food product slab, and the food product slab is advanced in a machine direction with respect to cutting tool 30. Cutting tool 30 is then moved toward the food product slab and contacts the food product slab to form a continuous second cutting pattern 50′ in the food product slab with respect to first cutting pattern 50, to form a plurality of food product cubes. Preferably, continuous second cutting pattern 50′ is formed in a transverse orientation with respect to the food product slab. In one preferred embodiment of this invention, the combination of continuous first cutting pattern 50 and continuous second cutting pattern 50′ forms a row of substantially identical food product cubes. For example, an upstream portion of continuous second cutting pattern 50′ contacts a downstream portion of continuous first cutting pattern 50 to form the row of substantially identical food product cubes.

Thus, in one preferred embodiment, this invention provides an apparatus and method for forming a plurality of food product pieces, such as food product cubes, from a food product base using an apparatus having a reciprocating cutting tool operatively connected to an ultrasonic resonant horn, wherein the food product source or base is simultaneously slit using a plurality of equally spaced longitudinally oriented first cutting blades, and cut using a plurality of transversely oriented second cutting blades positioned between and connected with adjacent first cutting blade at a first end portion thereof. As used in the specification and claims, food product base may include a variety of product stock including slabs, strips, sheets and loaves, as well as intermittent, continuous and discrete feed methods.

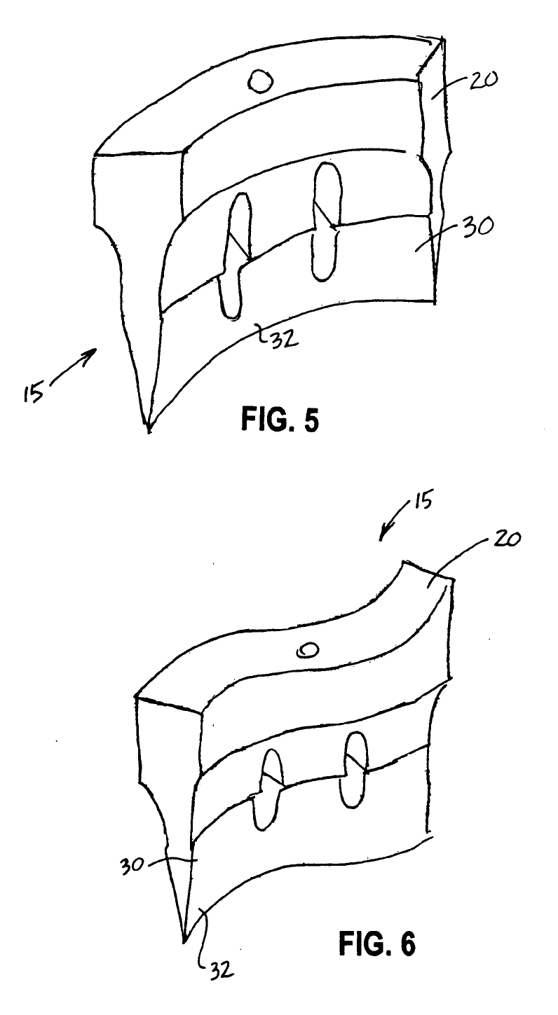

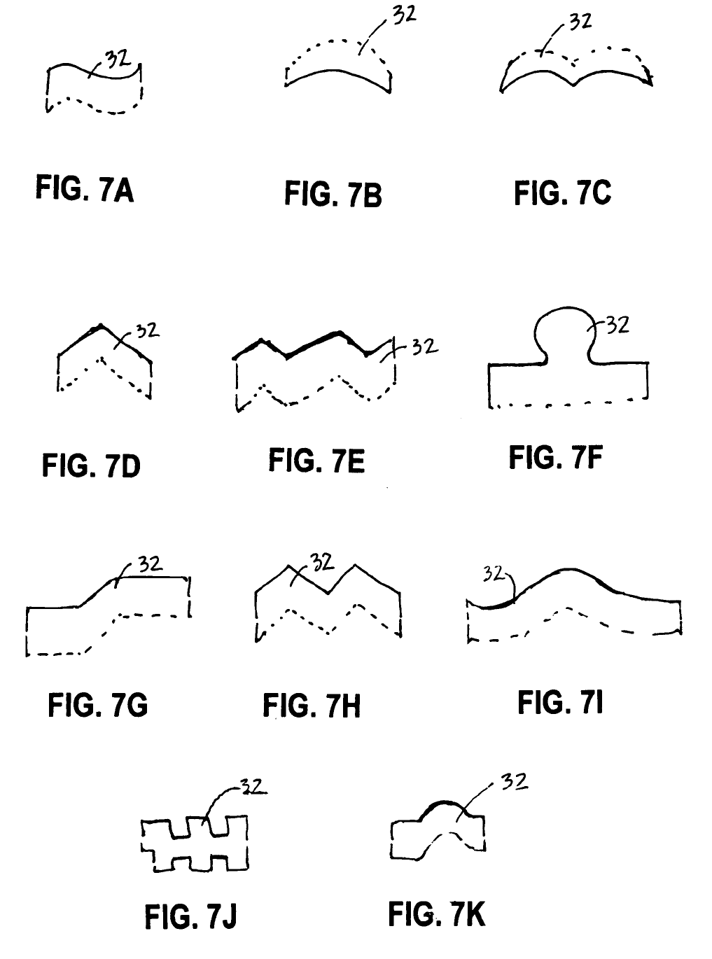

In one preferred embodiment of this invention, cutting tool 30 comprises at least one profiled cutting blade 32. Profiled cutting blade 32 can be integrated with ultrasonic horn 20 as a part or component of cutting tool 30, as shown for example in FIGS. 5 and 6, or profiled cutting blade 32 can be removably mounted with respect to and/or operatively connected to ultrasonic horn 20, as shown in FIG. 4, using any suitable mechanical and/or electrical connection, which properly transfers the ultrasonic energy supplied by ultrasonic horn 20 to profiled cutting blade 32 to cut or slit the food product base. Referring further to FIGS. 7A-7K, profiled cutting blade 32 can have any desirable or suitable profile, such as a wave-shaped profile (FIG. 7A), a crescent-shaped profile (FIG. 7B), a dove-shaped profile (FIG. 7C), a chevron-shaped profile (FIG. 7D), a tile-shaped profile (FIG. 7E), a puzzle-shaped profile (FIG. 7F), a ramp-shaped profile (FIG. 7G), an eagle-shaped profile (FIG. 7H), a crest-shaped profile (FIG. 7I), a step-shaped profile (FIG. 7J) or a hump-shaped profile (FIG. 7K). It should be apparent to those skilled in the art that cutting tool 30 may comprise any suitable profiled cutting blade 32 having any suitable or desirable profile shape.

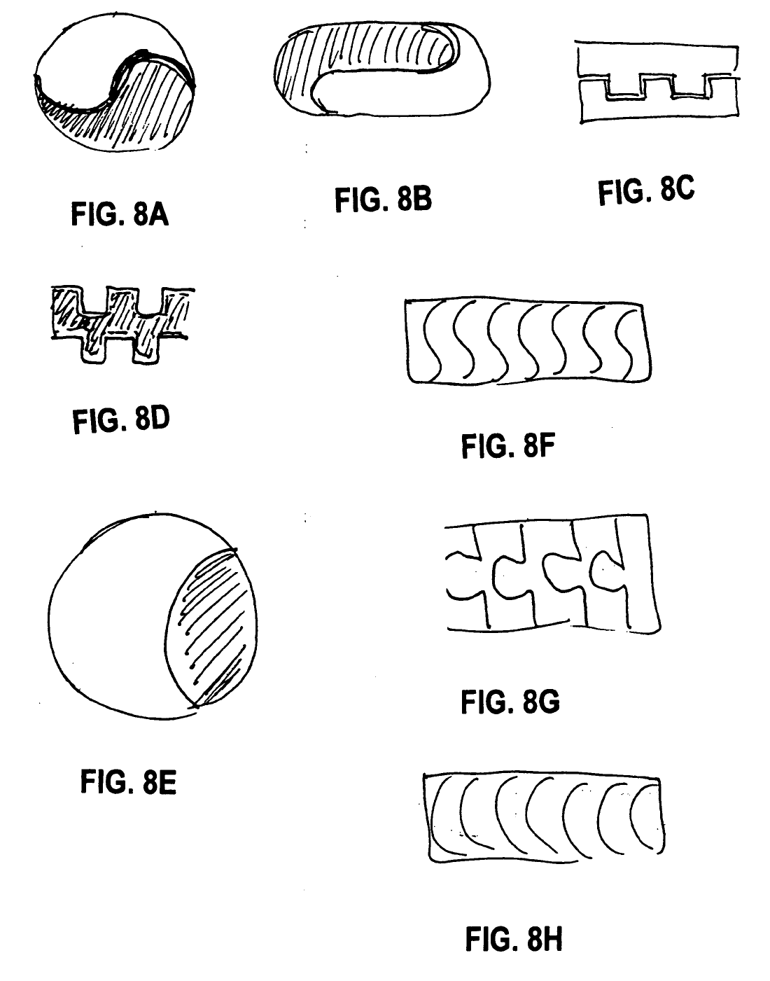

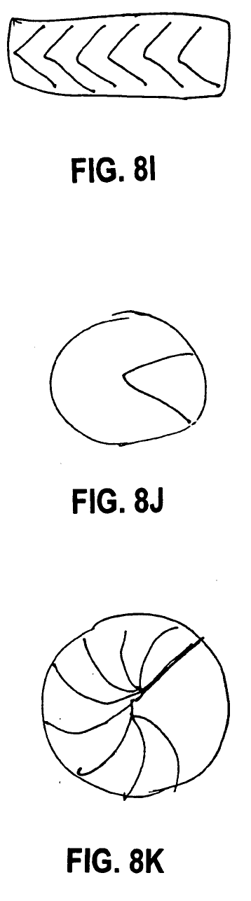

Further, referring to FIGS. 8A through 8K, profiled cutting blade 32 may be used to cut preshaped food product pieces to form separation lines that interconnect or engage food product pieces. For example, one or a series of profiled cuts imparted by profiled cutting blade 32 can produce a Yin-Yang cut in a preshaped food product piece (FIG. 8A), a cane cut (FIG. 8B), an interlocking step cut (FIGS. 8C and 8D), an eclipse cut (FIG. 8E), a twist cut (FIG. 8F), an interlocking puzzle cut (FIG. 8G), a crescent cut (FIG. 8H), a chevron cut (FIG. 8I), a pie piece cut (FIG. 8J) or a slice cut (FIG. 8K). One food processing advantage to the profiled cuts imparted by profiled cutting blade 32 is that the cuts can be positioned on the food product strips in such a way as to maximize the use of the food product strip and thereby minimize food product waste.

Profiled cutting blades 32, depending on the application, can be realized in both half wavelength and full wavelength types. Additionally, cutting blades 32 can be simple or composite, depending on whether cutting blades 32 are built from a solid piece, or one or more shaped elements, resonant or not, are connected to a “back driver” or mother horn, by means such as studs, brazing or electron beam welding, for example.

In one preferred embodiment of this invention, a food product slab extends along a machine direction on the input conveyor of apparatus 10. One or more cutting tools 30 are positioned to extend longitudinally, i.e. lengthwise along the same direction as a longitudinal direction of the food product slab. Preferably, cutting tools 30 include a profiled cutting blade 32, such as shown in FIGS. 7A through 7K. The one or more cutting tools 30 reciprocate with the movement of the food product slab to slit the food product slab longitudinally, thereby preferably creating a plurality of profiled strips of food product material. Alternatively, one or more strips of food product material may be introduced into the cutting step described below as straight strips of food product material.

One or more cutting tools 30 are preferably positioned downstream of the introduction of the straight or profiled strips of food product material formed during the food product slitting process. Cutting tools 30 are preferably positioned generally perpendicular to the machine direction of the one or more strips of food product material, i.e. in a transverse direction along a width of the food product strips. Each cutting tool 30 preferably includes a profiled cutting blade 32, such as shown in FIGS. 7A through 7K, that reciprocates with the movement of each strip of food product material through cutting tool 30, thereby creating individual food product pieces. Each piece has a profile corresponding with the profile of the one or more profiled cutting blades 32 used. The profiled cuts limit or prevent scrap or waste material, which is generally discarded, thereby reducing or limiting material waste and material cost. Further, the profiled cuts provide interesting edges for the food product pieces, which may, using certain profiled cutting blades, create interlocking or engageable food product pieces, as shown for example in FIGS. 8A through 8K.

Referring further to FIGS. 7A through 7K, profiled cutting blade 32, such as the wave-shaped profiled cutting blade as shown in FIG. 7A, imparts a profiled or shaped cut on the food product slab or strip. Similarly, profiled cutting blades 32 having a profile as shown in FIGS. 7B through 7K can be mounted on at least one cutting tool 30 to impart correspondingly shaped cuts on the food product slab or strip, resulting in identically shaped food product pieces. One or more profiled cutting blades 32 may be placed abreast to execute transverse cuts on longitudinally slit strips, resulting in identically wave-shaped food product pieces. Alternatively, one or more cutting tools 30 may be placed abreast and with corresponding profiled cutting blades 32 longitudinally aligned with the food product slab flow, to execute successive longitudinal cuts, similar to the stitching of a sewing machine, so as to slit the product slab into strips having side edges with an identically shaped profile.

In one preferred embodiment of this invention, a preshaped product, such as a pre-shaped circular food product piece as shown in FIGS. 8A and 8E, can be cut with a cutting tool 30 having a profiled cutting blade 32 to impart a Yin-Yang separation pattern or an eclipse separation pattern, respectively. Similarly, a pre-shaped oblong food product piece, such as shown in FIG. 8B, can be cut with a cutting tool 30 having a profiled cutting blade 32 to impart or create a separation pattern resulting in two cane-shaped food product pieces. Alternatively, a baked food product strip can be portioned with multiple cuts using a single profiled cutting blade 32 or one or more cuts with a cutting tool 30 having multiple profiled cutting blades 32 to produce a plurality of identically-shaped food product pieces having at least one desired or suitable profiled edge, such as shown in FIGS. 8F, 8G, 8H and 8I. As shown in FIGS. 8C, 8D and 8G, a baked food product strip can be portioned with multiple cuts, being the same or similar profile cut or a different or opposite profile cut, using a single profiled cutting blade 32 or one or more cuts with a cutting tool 30 having multiple profiled cutting blades 32, to produce a plurality of profiled food product pieces. The resulting food product pieces, in the form of step or puzzle pieces for example, are engageable or interlockable with similar profiled food product pieces. FIGS. 8J and 8K show pre-shaped circular food product pieces that can be cut with a cutting tool 30 having a profiled cutting blade 32 to impart a pie piece separation pattern or a slice separation pattern, respectively.

As a result of the above-described embodiments, a food product slab may be slit longitudinally with at least one ultrasonic cutting tool having a straight or profiled cutting blade to form a plurality of food product strips. The food product strips may next be cut transversely using an ultrasonic cutting tool having a straight or profiled cutting blade, thereby resulting in a food product piece having between one and four profiled edges, depending upon the desired food product piece shape. The method and apparatus of this invention thereby enables an infinite number of potential food product piece shapes depending upon the desired complexity of the cutting blades. Different combinations include profiled slitting and profiled cutting; profiled slitting and straight cutting; and straight slitting and profiled cutting. These various options greatly reduce the likelihood of scrap or waste food product base because a food product web will not typically result from such an arrangement.

One product made possible by the foregoing embodiment of this invention is the formation of a food product into a puzzle comprising any suitable number of food puzzle pieces. The product may be sold to a consumer with the food puzzle pieces assembled in a puzzle format. The consumer can disassemble the puzzle by disengaging the food puzzle pieces and then reassemble the food puzzle pieces as desired, for example.

The cutting tools of the present invention may be controlled and/or adjusted using linear servos. Linear servos may be mechanically connected to the ultrasonic horns to permit operation of cutting systems independently and/or dependently from adjacent cutting systems or tools, independently and/or dependently of the motion of the product through the apparatus and independently and/or dependently of previous in-line cutting cycles. Each module of blades may be programmed independently, including such parameters as speed, force, etc. Such adjustments may be made in process. In addition, vertical motion of the cutting blades may be programmed independently of horizontal motion of the product to optimize cuts through a particular product. Such linear servos may be safely immersed in liquid and/or food products. Finally, such linear servos do not have reliability issues associated with traditional machinery having springs, pulleys and/or chains, for example.

The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. An apparatus for cutting food product comprising:
an ultrasonic resonant horn; and
a reciprocating cutting tool mounted with respect to the ultrasonic resonant horn, the cutting tool comprising a cutting blade having a contoured cutting profile.

2. The apparatus of claim 1 wherein the contoured cutting profile comprises a curved profile.

3. The apparatus of claim 2 wherein the curved profile comprises a wave profile.

4. The apparatus of claim 1 further comprising a mother horn connected with respect to the ultrasonic resonant horn.

5. The apparatus of claim 1 wherein each cutting blade has a cutting depth of about 1 mm to about 100 mm.

6. The apparatus of claim 1 wherein at least a portion of the cutting blade comprises a polished carbide coating.

7. The apparatus of claim 1 wherein the ultrasonic resonant horn has a frequency of at least about 10 KHz.

8. The apparatus of claim 1 wherein the ultrasonic resonant horn has a frequency range of about 10 KHz to about 40 KHz.

9. An apparatus for forming a plurality of food products from a food product base comprising:
an ultrasonic resonant horn; and
a reciprocating cutting tool mounted with respect to the ultrasonic resonant horn, the cutting tool comprising at least one profiled blade element having a contoured cutting surface cutting through the food product base and forming individual food product pieces.

10. The apparatus of claim 9 wherein a cutting pattern formed in the food product is generally repeated and continuous.

11. A method for forming a plurality of food products from a food product base comprising:
forming a food product slab from the food product base;
conveying the food product slab through an apparatus comprising an ultrasonic resonant horn and a reciprocating cutting tool mounted with respect to the ultrasonic resonant horn, the cutting tool comprising a cutting blade having a contoured cutting profile;
forming a first contoured cutting pattern in the food product slab; and
advancing the food product slab with respect to the cutting tool.

12. The method of claim 11 further comprising:
reciprocating the cutting tool; and
forming a second contoured cutting pattern in the food product slab with respect to the first contoured cutting pattern to form at least one of the plurality of food products.

13. The method of claim 12 wherein the first contoured cutting pattern follows the second contoured cutting pattern with respect to the food product slab.

14. The method of claim 11 wherein the first contoured cutting pattern is transversely oriented with respect to the food product slab.

15. The method of claim 12 wherein the first contoured cutting pattern and the second contoured cutting pattern form at least one food product piece in a row of food product pieces.

16. The method of claim 12 wherein an upstream portion of the second contoured cutting pattern contacts a downstream portion of the first contoured cutting pattern to form a row of food product pieces.

17. The method of claim 11 wherein the food product slab comprises a circular slab and the first contoured cutting pattern halves the circular slab to form two food product pieces.

18. The method of claim 11 wherein the contoured cutting profile comprises a curved profile.

19. The method of claim 18 wherein the curved profile comprises a wave profile.

20. The method of claim 11 wherein the contoured cutting profile comprises a puzzle piece profile.
